(19) United States
(12) Patent Application Publication
(10) Pub. No.: US 2026/0131568 A1
(43) Pub. Date: May 14, 2026

(54) DROPLET FORMATION DEVICE AND DRIVING METHOD FOR EJECTION HEAD

(71) Applicants: Yusuke NONOYAMA, Sagamihara-shi (JP); Hidekazu YAGINUMA, Kawasaki-shi (JP); Takahiko MATSUMOTO, Kawasaki-shi (JP); Atsushi MIYAOKA, Yokohama-shi (JP); Daisuke ARAI, Tokyo (JP)

(72) Inventors: Yusuke NONOYAMA, Sagamihara-shi (JP); Hidekazu YAGINUMA, Kawasaki-shi (JP); Takahiko MATSUMOTO, Kawasaki-shi (JP); Atsushi MIYAOKA, Yokohama-shi (JP); Daisuke ARAI, Tokyo (JP)

(21) Appl. No.: 19/439,532

(22) Filed: Jan. 5, 2026

Related U.S. Application Data
(63) Continuation of application No. PCT/JP2024/017706, filed on May 13, 2024.

(30) Foreign Application Priority Data
Jul. 28, 2023 (JP) 2023-123889

(51) Int. Cl. B41J 2/045; B41J 2/14

(52) U.S. Cl. CPC B41J 2/04588; B41J 2/04581; B41J 2/14233; B41J 2/14274; B41J 2/1433

(57) ABSTRACT

A droplet formation device including an ejection head which ejects droplets of a liquid and a controller which supplies an electric signal and controls operations of the ejection head. The ejection head has a tubular liquid holding module which holds the liquid, and a vibration module which ejects the droplets based on the electric signal. The vibration module has a membranous element which has an ejection port from which the droplets are ejected and a vibration unit which causes the membranous element to vibrate based on the electric signal, wherein the vibration module covering one end of the liquid holding module and forming a liquid chamber which holds the liquid together with the liquid holding module. In the liquid chamber, the other end of the liquid holding module being open to the atmosphere, and the controller supplies the vibration unit with the electric signal having a drive frequency.

### CROSS-REFERENCE TO RELATED APPLICATIONS

This application is a continuation application of International Application No. PCT/JP2024/017706, filed on May 13, 2024, which is based upon Japanese Application No. 2023-123889, filed on Jul. 28, 2023, the entire contents of each are incorporated herein by reference.

### TECHNICAL FIELD

The present invention relates to a droplet formation device and a driving method for an ejection head.

The present application claims priority on Japanese Patent Application No. 2023-123889, filed Jul. 28, 2023, the content of which is incorporated herein by reference.

### BACKGROUND ART

Conventionally, inkjet-type droplet formation devices are known as technologies for ejecting liquid bodies (liquids) such as ink at desired positions.

In recent years, it is required that various types of liquids are ejected by droplet formation devices, instead of the inks which were used for conventional two-dimensional printing. For example, examples of the liquids that are to be ejected include dispersions as well as solutions. As the dispersed substances (particles) included in dispersions, there are organic materials such as resin materials, inorganic materials such as metal particles and oxide particles, and biological materials such as cells and genes.

Non Patent Document 1 discloses a configuration of a droplet ejection head having an ink reservoir that is open to the atmosphere, wherein droplets are formed by vibrating a membranous element having an ejection port, which is provided at the bottom of the reservoir, while stirring dispersed substances in the ink.

### SUMMARY OF INVENTION

### Technical Problem

In the configuration described in Non Patent Document 1, droplets are formed by vibrating a membranous element so as to be matched with the resonance frequency of the ink stored in the reservoir. However, in this case, when the amount of ink stored in the reservoir changes, the resonance frequency of the ink also changes, making droplet formation difficult. In order to form droplets continuously with the configuration described in Non Patent Document 1, the drive signals (waveforms) for vibrating the membranous element must be changed in accordance with the amount of ink. Thus, control thereof was difficult.

The present invention was made in view of these circumstances, and an objective thereof is to provide a droplet formation device capable of conveniently and stably forming droplets. An additional objective is to also provide a driving method for an ejection head capable of conveniently and stably forming droplets.

### Solution to Problem

In order to solve the above-mentioned problem, one embodiment of the present invention provides a droplet formation device comprising an ejection head which ejects droplets of a liquid; and a control unit which supplies an electric signal and controls operations of the ejection head; the ejection head including a tubular liquid holding module which holds the liquid, and a vibration module which ejects the droplets based on the electric signal; the vibration module including a membranous element which has an ejection port from which the droplets are ejected, and a vibration unit which causes the membranous element to vibrate based on the electric signal; the vibration module covering one end of the liquid holding module and forming a liquid chamber which holds the liquid together with the liquid holding module; in the liquid chamber, the other end of the liquid holding module being open to the atmosphere; and the control unit supplies the vibration unit with the electric signal having a drive frequency as shown in Expression (1) below:

$$[ Drive frequency ] = ( [ Resonance frequency of structural vibrations of vibration unit ] / n ) \times a \qquad ( 1 )$$

wherein n represents an integer from 1 to 100 and a represents 0.9 to 1.1.

### Advantageous Effects of Invention

According to the present invention, a droplet formation device capable of easily and stably forming droplets can be provided. Additionally, a driving method for an ejection head capable of easily and stably forming droplets can be provided.

### BRIEF DESCRIPTION OF DRAWINGS

FIG. 1 is a schematic view of a droplet formation device 1.

FIG. 2 is a schematic view of an ejection head 110.

FIG. 3 is a partially enlarged view of the ejection head 110.

FIG. 4 is a diagram for explaining a method for measuring a resonance frequency of structural vibrations in a vibration unit.

FIG. 5 is an example of vibration spectra determined by measurement.

FIG. 6 is a diagram indicating an example of a drive waveform set from measurement results in FIG. 5.

### DESCRIPTION OF EMBODIMENTS

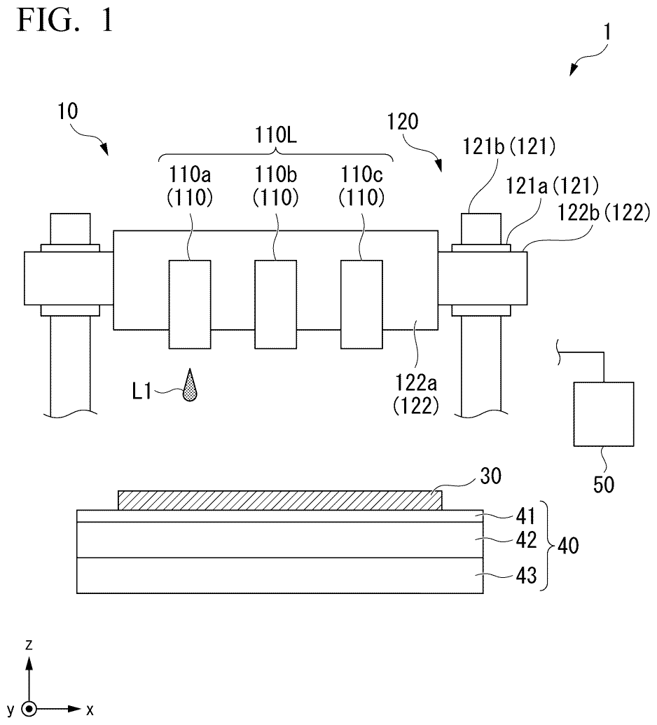

Hereinafter, the droplet formation device and the driving method for an ejection head according to the present embodiment will be explained with reference to FIG. 1 to FIG. 6. In all of the drawings below, the dimensions, proportions, etc. of the respective constituent elements are changed, as appropriate, to make the drawings easier to see.

FIG. 1 is a schematic view of the droplet formation device 1 in the present embodiment. As illustrated in FIG. 1, the droplet formation device 1 has an ejection unit 10, a droplet receiving element 30, a placement module 40, and a control unit 50.

In the explanation below, an xyz rectangular coordinate system is established and the positional relationships between respective elements will be explained with reference to this xyz rectangular coordinate system. In this case, a prescribed direction in the horizontal plane is defined as the x-axis direction, the direction in the horizontal plane orthogonal to the x-axis direction is defined as the y-axis direction, and the direction (i.e., the vertical direction) orthogonal to both the x-axis direction and the y-axis direction is defined as the z-axis direction.

Additionally, the vertical upward direction is defined as the +z direction and the vertical downward direction is defined as the −z direction. In the explanation below, “up” as in “upward” and “upper surface” and “down” as in “downward” and “lower surface” have the same meaning such as those described above.

Furthermore, in the explanation below, “plan view” refers to viewing an object from above (the +z direction), and “planar shape” refers to the shape when the object is viewed from above.

### <<Ejection Unit>>

As illustrated in FIG. 1, the ejection unit 10 has an ejection head 110 and a transport module 120.

### <Ejection Head>

The ejection head 110 ejects droplets L1. The ejection unit 10 may have just one ejection head 110 or may have a plurality thereof. The ejection head 10 illustrated in the drawing has three ejection heads 110a, 110b, and 110c. The three ejection heads 110a, 110b, 110c will be referred to collectively as an ejection unit 110L.

The ejection heads 110a, 110b, 110c may each have the same configuration or may have mutually different configurations.

The three ejection heads 110a, 110b, 110c are arrayed in a direction (the x direction in the drawing) intersecting the liquid ejection direction (the −z direction in the drawing) in which the liquid is ejected from the ejection head 110.

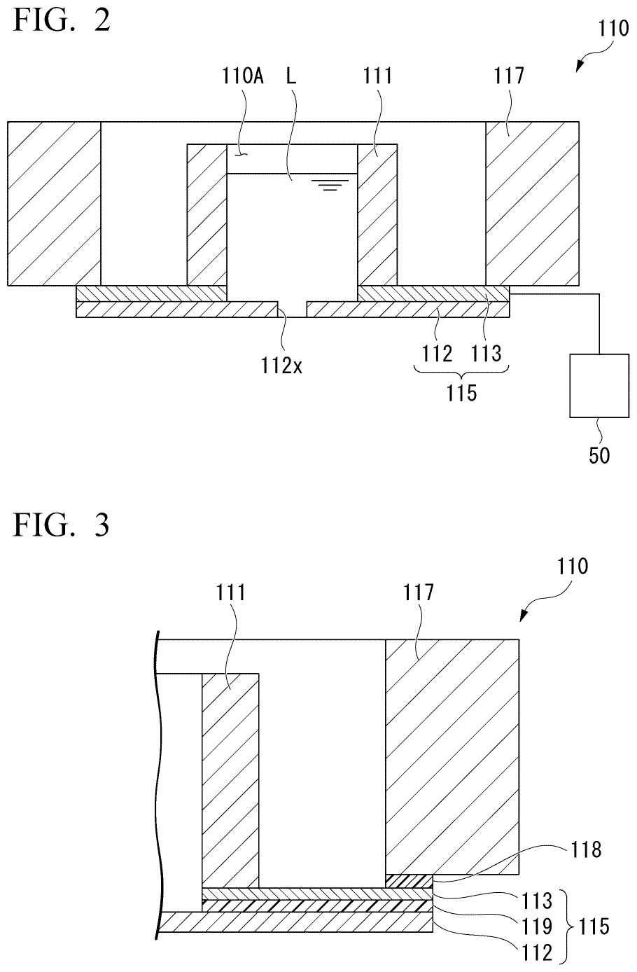

FIG. 2 is a schematic view of the ejection head 110. The ejection head 110 has a liquid holding module 111, a vibration module 115, and a fixing member 117.

The space surrounded by the liquid holding module 111 and the vibration module 115 is a liquid chamber 110A of the ejection head 110. The liquid chamber 110A holds a liquid (liquid L) that is the source of the droplets L1.

The amount of the liquid L held in the liquid chamber 110A is not particularly limited. For example, the amount of the liquid L held in the liquid chamber 110A may be from 1 μl to approximately 1 ml. When ejecting an expensive liquid such as a cell suspension from the droplet formation device 1, the amount of the liquid L held in the liquid chamber 110A may be from 1 μl to approximately 200 μl.

The liquid L ejected by the droplet formation device 1 is not particularly restricted and can be appropriately selected in accordance with the purpose. The liquid L may be, for example, purified water (ion-exchanged water, distilled water), physiological saline, various types of organic solvents such as an alcohol, a mineral oil, vegetable oils, etc.

The liquid L may be a dispersion in which particles are dispersed.

The particles included in the liquid L may be organic materials such as polymer particles, or inorganic materials such as metal fine particles or inorganic oxide particles. Examples of metal fine particles include silver particles, copper particles, etc. Examples of inorganic fine particles include titanium oxide particles and silicon oxide particles.

Additionally, as the particles, cells may be used. The cells may be plant cells or animal cells. Examples of animal cells, in particular, include cells from humans.

In the case in which the liquid Lis a dispersion, the dispersion medium may be water, alcohol, etc. The dispersion medium may include a wetting agent for suppressing evaporation, and/or a surfactant for lowering the surface tension. In the case in which the particles are cells, the dispersion medium may be a known buffer solution such as phosphate buffered saline or Hank's balanced salt solution, or may be a culture medium for use with various types of cells.

The ejection heads 110a, 110b, 110c may each hold the same liquid L or may hold mutually different liquids L.

### (Liquid Holding Module)

The liquid holding module 111 is a tubular element that has openings at both ends in the z-axis direction. The liquid holding module 111 may, for example, be a cylindrical element. The material of the liquid holding module 111 may, for example, be a metal such as stainless steel, nickel, or aluminum, a plastic (resin material) such as ABS, polycarbonate, or a fluororesin, a ceramic such as silicon dioxide, alumina, or zirconia, or silicon, etc.

A lower end, which is one end of the liquid holding module 111, is closed by being covered by the vibration module 115. An upper end, which is the other end of the liquid holding module 111, is open to the atmosphere. If the liquid holding module 111 is open to the atmosphere in the upward direction, the liquid L held in the liquid holding module 111 cannot be easily pressurized when ejecting droplets, and damage to cells can be suppressed.

### (Vibration Module)

The vibration module 115 has a nozzle plate (membranous element) 112 and a vibration unit 113. Although the vibration module 115 illustrated in FIG. 2 has the vibration unit 113 located above and the nozzle plate 112 located below, the structure is not limited thereto, and the nozzle plate 112 may be above and the vibration unit 113 may be below.

### (Nozzle Plate (Membranous Element))

The nozzle plate 112 is a membranous element having (an) ejection port(s) 112x. The nozzle plate 112 closes the lower end of the liquid holding module 111 and, together with the liquid holding module 111, forms the liquid chamber 110A for holding the liquid L. The ejection port(s) 112x communicate(s) with the liquid holding module 111.

The planar shape, the size in plan view, the material, and the structure of the nozzle plate 112 are not particularly restricted, and can be appropriately selected in accordance with the purpose.

The planar shape of the outer edges of the nozzle plate 112 may be, for example, circular, elliptical, rectangular, square, diamond-shaped, etc. For example, in the case in which the shape of the outer edges of the nozzle plate 112 is circular, the nozzle plate 112 is a ring-shaped element.

As one example, the nozzle plate 112 can be a circular element having a diameter of 20 mm and an average thickness of 0.05 mm.

The nozzle plate 112 has ends that are not supported on the ejection port 112x side. The ends on the ejection port 112x side can vibrate up and down. Due to the ends of the nozzle plate 112 on the ejection port 112x side vibrating, downward forces are applied to the liquid L which is located near the ejection port(s) 112x, thereby ejecting the droplets L1 from the ejection port(s) 112x.

If the material of the nozzle plate 112 is too soft, the nozzle plate 112 will easily vibrate, making it difficult to immediately suppress the vibrations when not ejecting the liquid L. Therefore, a material having a certain degree of hardness is preferably used.

Additionally, in the case in which the liquid L to be ejected is a cell dispersion, the material of the nozzle plate 112 is preferably a material to which the cells will not easily adhere. As such a material, a highly hydrophilic material is preferable.

Examples of such materials include, for example, metals, ceramics, polymer materials, etc.

More specifically, the material of the nozzle plate 112 may be stainless steel, nickel, aluminum, silicon dioxide, alumina, zirconia, ABS, polycarbonate, a fluororesin, etc. Furthermore, a composite material obtained by coating the surface of the nozzle plate 112, formed from a material different from the above-mentioned materials, with the aforementioned metal, ceramic, or a synthetic phospholipid polymer (for example, Lipidure, manufactured by NOF Corp.) simulating a cell membrane can be used.

The number arrayed, the form of the array, the spacing (pitch), the opening shapes, the sizes of the openings, etc. of the ejection ports 112x are not particularly restricted, and can be appropriately selected in accordance with the purpose.

The opening shape of the ejection port(s) 112x can be appropriately selected in accordance with the purpose. The opening shape of the ejection port(s) 112x may be, for example, circular, elliptical, square, etc. Among the above, the opening shape of the ejection port(s) 112x is preferably circular.

The average opening diameter of the ejection port(s) 112x is not particularly restricted and can be appropriately selected in accordance with the purpose. In the case in which the liquid L to be ejected is a dispersion, in order to avoid the dispersed substance such as cells dispersed in the liquid L jamming the ejection port(s) 112x, the opening shape of the ejection port(s) 112x is preferably two or more times the largest diameter of the dispersed substance.

In the case in which the dispersed substance is animal cells, particularly human cells, the average opening diameter of the ejection port(s) 112x is preferably 10 μm or more and 1000 μm or less. The sizes of human cells differ largely depending on the type of cell, and are generally 5 μm or more and 50 μm or less. Additionally, in the case in which the dispersed substance consists of cell masses (spheroids), the size of the cell masses is several tens of μm to several mm. For this reason, blockage of the ejection ports can be suppressed by setting the ejection port(s) 112x to be of the above-mentioned size, and forming the ejection port(s) 112x having an appropriate average opening diameter in accordance with the cells to be ejected.

Although making the opening diameter of the ejection port(s) 112x large allows larger cell masses to be ejected, stable ejection becomes more difficult as the opening diameter becomes larger. By setting the average opening diameter of the ejection port(s) 112x to be at most 1000 μm, many cell masses can be stably ejected. Additionally, in order to achieve stable ejection, the upper limit of the average opening diameter of the ejection port(s) 112x is preferably 200 μm or less.

The position(s) of the ejection port(s) 112x in the nozzle plate 112 is/are not particularly restricted and may be appropriately selected in accordance with the purpose. For example, the position may be at the center of the nozzle plate in plan view, or may be at positions other than the center of the nozzle plate 112 in plan view.

Additionally, the number of ejection port(s) 112x in the nozzle plate 112 may be singular or may be plural. A nozzle plate 112 having a plurality of ejection ports 112x can be favorably employed in a cylindrical liquid holding module 111. In a nozzle plate 112 that is exposed to the interior space of the liquid holding module 111, the plurality of ejection ports 112x may be arranged equidistantly from the central axis of the liquid holding module 111. By using such an arrangement, in the nozzle plate 112, the vibration state at each of the ejection ports 112x is made equivalent and it becomes possible to simultaneously eject droplets from the plurality of ejection ports 112x.

The liquid holding modules in which a nozzle plate 112 having a plurality of ejection ports 112x can be employed are not limited to being cylindrical. It can be employed in liquid holding modules of various shapes as long as the vibration state of the nozzle plate 112 is made equivalent at the plurality of ejection ports 112x. For example, in the case of an elliptic cylindrical liquid holding module, by providing an ejection port at each position, which is aligned with a focal point, in an xy cross-section (rectangular) of the liquid holding module, the vibration state becomes equivalent at each ejection port, and droplets can be simultaneously ejected.

Similarly, in the case in which the liquid holding module is square tubular, by assuming an xy cross-section of the liquid holding module and providing ejection ports at arbitrary points in the cross-section, and furthermore providing ejection ports at positions symmetric (line-symmetric, point-symmetric) to said arbitrary points in the cross-section, the vibration state becomes equivalent at each ejection port.

### (Vibration Unit)

The vibration unit 113 vibrates the nozzle plate 112 based on an electric signal that is input, causing droplets L1 to be ejected from the ejection port(s) 112x.

The vibration unit 113 is installed on the upper surface of the nozzle plate 112.

The shape, size, material, and structure of the vibration unit 113 are not particularly restricted and can be appropriately selected in accordance with the purpose.

The shape and arrangement of the vibration unit 113 are not particularly restricted as long as the effects of the invention are not compromised, and they can be appropriately designed in accordance with the shape of the nozzle plate 112. For example, in the case in which the planar shape of the nozzle plate 112 is ring-shaped, the vibration unit 113 is preferably provided concentrically around the ejection port(s) 112x.

The vibration unit 113 may be a piezoelectric element or an electromagnetic solenoid, and a piezoelectric element is favorably used. The piezoelectric element can, for example, have a structure in which electrodes are provided for applying voltages to the upper surface and to the lower surface of a piezoelectric material. In this case, by applying a voltage across the upper and lower electrodes of the piezoelectric element from the control unit 50, compressive stress is applied in the plane-horizontal direction of the membrane, and the nozzle plate 112 can be vibrated in the plane-vertical direction of the membrane.

The piezoelectric material is not particularly restricted and can be appropriately selected in accordance with the purpose. For example, examples thereof include lead zirconate titanate (PZT), bismuth iron oxides, metal niobates, barium titanate, or materials obtained by adding metals or other oxides to these materials. Among the above, lead zirconate titanate (PZT) is preferable.

The vibration mode in the piezoelectric element is not particularly restricted and can be appropriately selected in accordance with the purpose. For example, there are longitudinal modes and bending modes. As a longitudinal-mode piezoelectric element, it is possible to use, for example, a lamination-type piezoelectric element that is laminated in the z direction and that, when a voltage is applied, stretches in the longitudinal direction (z direction) and contracts in the transverse direction (xy direction).

Additionally, as a bending-mode piezoelectric element, it is possible to use, for example, a bimorph-type piezoelectric element that, when a voltage is applied, deforms and bends so that the position of one end of the piezoelectric element is displaced.

### (Fixing Member)

The fixing member 117 is a tubular element that surrounds the periphery of the liquid holding module 111. The fixing member 117, at the lower end thereof, holds the vibration module 115. Additionally, the fixing member 117 is used for attaching the ejection head 110 to the transport module 120.

The shape of the fixing member 117 is not limited to being tubular, and various shapes can be employed as long as they can hold the vibration module 115 and can attach the ejection head 110 to the transport module 120.

FIG. 3 is a partially enlarged view of the ejection head 110. As illustrated in FIG. 3, the fixing member 117 is bonded to the vibration module 115 by a first adhesive layer 118.

The material forming the first adhesive layer 118 is an adhesive of a hardness that can follow the displacement of the vibration unit 113 of the vibration module 115 without hindering the displacement of the vibration unit 113. The elastic modulus of the material forming the first adhesive layer 118 is preferably 1 MPa or more and 100 MPa or less, which is the elastic modulus range of common rubber, and is more preferably be 10 MPa or more and 100 MPa or less.

Meanwhile, the vibration module 115 has a second adhesive layer 119. The second adhesive layer 119 is sandwiched between the nozzle plate 112 and the vibration unit 113, and bonds the nozzle plate 112 with the vibration unit 113.

The material forming the second adhesive layer 119 is preferably harder than the material forming the first adhesive layer 118 in order to allow the displacement of the vibration unit 113 to be more easily transmitted to the nozzle plate 112.

For example, a silicone-based elastic adhesive can be favorably used as the material of the first adhesive layer 118. Additionally, an epoxy-based adhesive can be favorably used as the material of the second adhesive layer 119.

The “material forming the first adhesive layer 118” and the “material forming the second adhesive layer 119” mentioned above refer to substances obtained by curing the silicone-based elastic adhesive or the epoxy-based adhesive. Regarding the magnitude relationship of the elastic modulus of the material forming the first adhesive layer 118 and the material forming the second adhesive layer 119, they may be compared by using published values which are available from the manufacturers for the elastic modulus of the cured adhesives that are used, or they may be compared by using measured values for the elastic modulus of the cured materials.

When a prescribed electric signal (voltage pulse) is applied to the vibration unit 113, a central portion of the vibration unit 113, which is not fixed to the fixing member 117, deforms up and down. Due to this deforming action, localized pressure is applied to the liquid L near the nozzle plate 112 in the liquid chamber 110A, causing a flow of the liquid L towards the ejection port(s) 112x. Part of this flow is ejected from the ejection port(s) 112x as droplets.

With the droplet formation device 1, the above-mentioned operation will not cause a large pressure to be applied to the entire liquid chamber, as in known inkjet heads having closed liquid chambers. For this reason, when ejecting a dispersion in which cells are dispersed, damage to the cells in the dispersion can be suppressed.

### <Transport Module>

The transport module 120 has a first movement element 121 and a second movement element 122.

### (First Movement Element)

The first movement element 121 has a supporting element 121a and a linear movement element 121b. The first movement element 121 is a pair of elements provided on the +x-side end and on the −x-side end of the second movement element 122.

The supporting element 121a is an element that has rectangle-shape in a view seen from the ty direction and that supports the second movement element 122.

The linear movement element 121b is a long element extending in the z-axis direction. The linear movement element 121b moves the supporting element 121a vertically in the z-axis direction. As the linear movement element 121b, for example, a known linear actuator provided with a stepping motor as the drive source can be employed.

The first movement element 121 moves the supporting element 121a in the z-axis direction, thereby moving the ejection unit 110L, which is supported by the second movement element 122, in the z-axis direction.

### (Second Movement Element)

The second movement element 122 has a supporting element 122a and a linear movement element 122b.

The supporting element 122a is an element that has a rectangle-shape in a view seen from the +y direction and that supports the ejection unit 110L.

The linear movement element 122b is a long element extending in the x-axis direction. The linear movement element 122b moves the supporting element 122a horizontally in the x-axis direction. Both ends of the linear movement element 122b are supported by the supporting elements 121a of the first movement element 121.

As the linear movement element 122b, for example, a known linear actuator provided with a stepping motor as the drive source can be employed.

The second movement element 122 moves the supporting element 122a in the x-axis direction, thereby moving the ejection unit 110L, which is supported by the supporting element 122a, in the x-axis direction.

### <<Droplet Receiving Element>

The droplet receiving element 30 is disposed in the ejection direction to which the droplets L1 is ejected from the ejection unit 10, and the droplets L1 land thereon. The droplet receiving element 30 can be selected from structures which have various types of materials and various shapes in accordance with the purpose of ejecting the liquid.

### <<Placement Module>

The placement module 40 places the droplet receiving element 30. The placement module 40 has an x-stage 41, a y-stage 42, and a base 43.

The x-stage 41 supports and immobilizes the droplet receiving element 30. Additionally, the x-stage 41 moves the droplet receiving element 30 horizontally in the x-axis direction.

The y-stage 42 moves the x-stage 41 horizontally in the y-axis direction. The base 43 supports the y-stage 42.

As the placement module 40, a known configuration for an xy-stage can be employed.

### <<Control Unit>>

The control unit 50 prepares electric signals for operating the respective units of the droplet formation device 1, and controls the respective units by supplying the electric signals thereto. The control unit 50, for example, makes drive signals to be supplied to the ejection unit 10 and to the transport module 40, and controls the operations of the respective units by supplying the drive signals to the respective units.

The control unit supplies, to the vibration unit 113 of the vibration module 115, an electric signal having a drive frequency as in Expression (1) below. That is, as the driving method for the ejection head, the control unit supplies the vibration unit 113 with an electric signal having a drive frequency as in Expression (1) below.

$$[ Drive frequency ] = ( [ Resonance frequency of structural vibrations of vibration unit ] / n ) \times a \qquad ( 1 )$$

(In the above, n represents an integer from 1 to 100 and a represents 0.9 to 1.1.)

The above n is preferably an integer from 1 to 10.

The above Expression (A) indicates that the drive frequency of the vibration unit 113 is approximately 1/integer of the resonance frequency of structural vibrations of the vibration unit 113. The above-mentioned drive frequency does not need to be strictly 1/integer of the resonance frequency, and the coefficient a is set as a margin of tolerance.

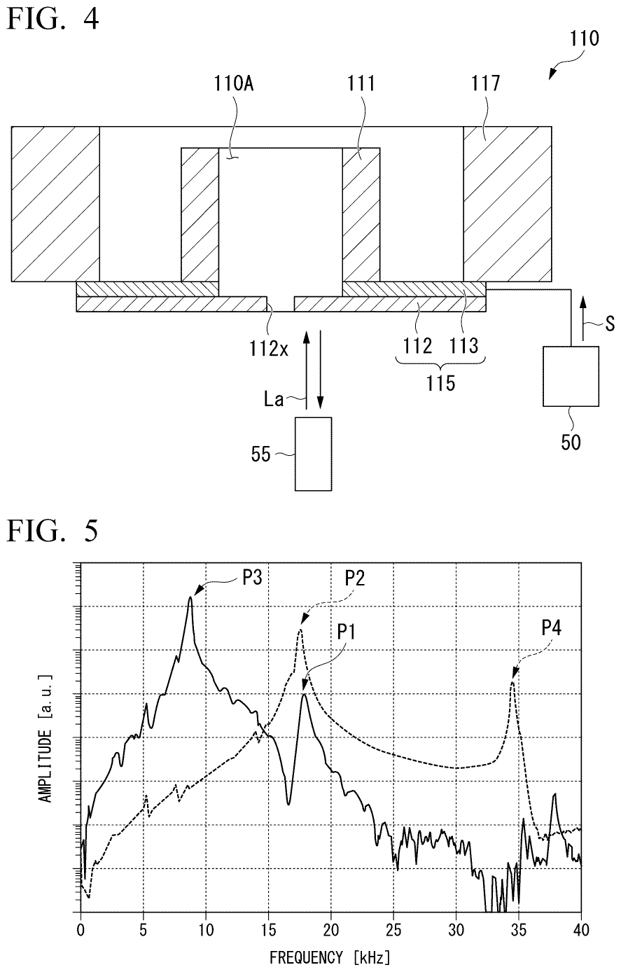

In this case, the “resonance frequency of structural vibrations of the vibration unit” can be measured in the manner indicated below. FIG. 4 is a diagram for explaining a method for measuring the resonance frequency of structural vibrations in the vibration unit.

As illustrated in FIG. 4, white noise voltage is applied, as the electric signal S, from the control unit 50 to the vibration unit 113 in the ejection head 110. In this state, the vibrations of the nozzle plate 112 near the ejection port(s) 112x are measured using a vibrometer 55. As the vibrometer 55, a known laser Doppler vibrometer can be used. In the state in which the white noise voltage is being applied to the vibration unit 113, the nozzle plate 112 is irradiated with a measuring laser beam La from the vibrometer 55, and the vibrations created in the vibration unit 113 by the white noise are measured.

The above-mentioned measurement is performed (a) in the case in which the liquid chamber 110A is filled with water, and (b) in the case in which the liquid chamber 110A is empty.

FIG. 5 is an example of vibration spectra determined by the above-mentioned measurement. In FIG. 5, the solid line is an example of the vibration spectrum when the liquid chamber 110A is filled with water, and the dotted line is an example of the vibration spectrum when the liquid chamber 110A is empty. In FIG. 5, the horizontal axis indicates the frequency (units: kHz) and the vertical axis indicates the amplitude (arbitrary units).

As is clear from FIG. 5, the peak P1 of the vibration spectrum indicated by the solid line and the peak P2 of the vibration spectrum indicated by the dotted line are resonance points appearing at the same frequency (around 18 kHz) regardless of the amount of water in the liquid chamber 110A. The vibrations at these peaks match the resonance frequency of the vibration unit 113 being used in the unloaded state, and can be understood to be caused by structural vibrations of the vibration unit 113. As the resonance frequency of the vibration unit 113 in the unloaded state, the manufacturer's published value can be employed.

In contrast therewith, the peak P3 of the vibration spectrum indicated by the solid line and the peak P4 of the vibration spectrum indicated by the dotted line show different resonance frequencies, according to the amount of water in the liquid chamber 110A. These resonance points are known to be due to resonance of so-called spring-mass vibrations, which are mainly determined by the elasticity (spring) of the nozzle plate 112 and the mass (mass) of water held above the nozzle plate 112.

From the above-mentioned measurements, the [Resonance frequency of structural vibrations of vibration unit] in the ejection head 110 used in the measurements can be determined to be approximately 18 kHz. For this reason, droplets can be favorably ejected by supplying the vibration unit 113 with an electric signal having a drive frequency that is approximately 1/integer of 18 kHz (([Resonance frequency of structural vibrations of vibration unit]/n)× a) from the control unit 50. The resonance frequency used for calculation is the measurement value (to three significant figures) obtained from the above-mentioned measurements.

It is preferable that the drive frequency of the nozzle plate 112 and the resonance frequency of the structural vibrations of the nozzle plate 112 are substantially matched (n=1 in Expression (1)).

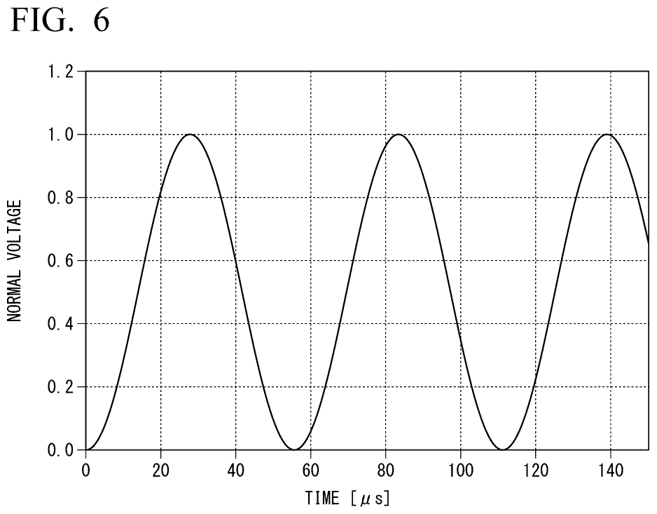

FIG. 6 is a diagram illustrating an example of a drive waveform set from the measurement results in FIG. 5. The drive waveform indicated in FIG. 6 is a sine wave which is set with a period of 55.6 μs, which corresponds to the vibration period at a frequency of 18 kHz. The drive waveform does not necessarily need to be a continuous sine wave, and may be a combined wave which is obtained by combining waveforms and intended to stabilize the ejection of droplets, wherein the combined wave may have a waveform with a frequency which is substantially matching the resonance frequency.

The inventors confirmed that, when a drive waveform with a drive frequency which is substantially matching the resonance frequency at the peak P3 in FIG. 5 was set and an electric signal with said drive waveform was supplied to the vibration unit 113, droplets were able to be ejected only from when the liquid chamber 110A was full of water until the volume became 89% of the initial volume. This is thought to be because, as a result of the amount of water in the liquid chamber 110A decreasing due to continued ejection of droplets, the frequency of the peak P3 moved to the higher frequency side, causing the resonance frequency to deviate from the drive frequency.

In contrast therewith, it was confirmed that, when an electric signal with the drive waveform indicated in FIG. 6 was supplied to the vibration unit 113 in the ejection head 110 in which the vibration spectra indicated in FIG. 5 were measured, droplets were able to be continuously ejected from when the liquid chamber 110A was full of water until the liquid chamber 110A became empty.

The drive frequency of the nozzle plate 112 may be 1/integer of the resonance frequency of the structural vibrations of the nozzle plate 112. By setting such a drive frequency, the residual vibrations from a certain ejection can be expected not to affect the next ejection.

According to the droplet formation device 1 having the configuration as described above, droplets can be conveniently and stably formed.

While examples of preferred embodiments according to the present invention have been explained with reference to the attached drawings, the present invention is not limited to these examples. The respective shapes, combinations, etc. of the constituent elements indicated in the above-mentioned examples are merely exemplary, and various changes can be made, based on design requirements, etc., within a range not departing from the gist of the present invention.

One embodiment of the present invention for solving the above-mentioned problem encompasses the embodiments below.

[1] A droplet formation device comprising an ejection head which ejects droplets of a liquid; and a control unit which supplies an electric signal and controls operations of the ejection head; the ejection head includes a tubular liquid holding module which holds the liquid, and a vibration module which ejects the droplets based on the electric signal; the vibration module includes a membranous element which has an ejection port from which the droplets are ejected, and a vibration unit which causes the membranous element to vibrate based on the electric signal; the vibration module covering one end of the liquid holding module and forming a liquid chamber, which holds the liquid, together with the liquid holding module; in the liquid chamber, the other end of the liquid holding module being open to the atmosphere; and the control unit supplies the vibration unit with the electric signal having a drive frequency as shown in Expression (1) below:

$$[ Drive frequency ] = ( [ Resonance frequency of structural vibrations of vibration unit ] / n ) \times a \qquad ( 1 )$$

wherein n represents an integer from 1 to 100 and a represents 0.9 to 1.1.

[2] The droplet formation device according to [1], wherein n is equal to 1.

[3] The droplet formation device according to [1] or [2], wherein the vibration unit is a piezoelectric element.

[4] The droplet formation device according to any one of [1] to [3], further having a tubular fixing member surrounding a periphery of the liquid holding module; the fixing member being adhered to the vibration module by a first adhesive layer; and an elastic modulus of a material forming the first adhesive layer is 1 MPa or more and 100 MPa or less.

[5] The droplet formation device according to [4], wherein the vibration unit and the membranous element are bonded by a second adhesive layer; and a material forming the second adhesive layer is harder than the material forming the first adhesive layer.

[6] A driving method for an ejection head which ejects droplets of a liquid, wherein the ejection head comprises a tubular liquid holding module which holds the liquid, and a vibration module which ejects the droplets based on an electric signal; the vibration module has a membranous element which has an ejection port from which the droplets are ejected, and a vibration unit which causes the membranous element to vibrate based on the electric signal; the vibration module covers one end of the liquid holding module and forms a liquid chamber, which holds the liquid, together with the liquid holding module; in the liquid chamber, the other end of the liquid holding module is open to the atmosphere; and the electric signal having a drive frequency as shown in Expression (1) below is supplied to the vibration unit:

$$[ Drive frequency ] = ( [ Resonance frequency of structural vibrations of vibration unit ] / n ) \times a \qquad ( 1 )$$

wherein n represents an integer from 1 to 100 and a represents 0.9 to 1.1.

### REFERENCE SIGNS LIST

1 Droplet formation device
50 Control unit
110 Ejection head
110A Liquid chamber
111 Liquid holding module
112 Nozzle plate (membranous element)
112x Ejection port
113 Vibration unit
115 Vibration module
117 Fixing member
118 First adhesive layer
119 Second adhesive layer
L Liquid
L1 Droplets
S Electric signal

### CITATION LIST

### Non Patent Document

Non Patent Document 1: Gokhan P., et al. “Piezoelectric droplet ejector for ink-jet printing of fluids and solid particles”, REVIEW OF SCIENTIFIC INSTRUMENTS, volume 74, number 2, p. 1120-1127, 2003

1. A droplet formation device comprising
an ejection head which ejects droplets of a liquid, and
a control unit which supplies an electric signal and controls operations of the ejection head,
wherein the ejection head includes
a tubular liquid holding module which holds the liquid, and
a vibration module which ejects the droplets based on the electric signal,
wherein the vibration module includes
a membranous element which has an ejection port from which the droplets are ejected, and
a vibration unit which causes the membranous element to vibrate based on the electric signal,
wherein the vibration module covering one end of the liquid holding module and forming a liquid chamber which holds the liquid together with the liquid holding module,
wherein, in the liquid chamber, the other end of the liquid holding module being open to the atmosphere, and
wherein the control unit supplies the vibration unit with the electric signal having a drive frequency as shown in Expression (1) below:
$$[ Drive frequency ] = ( [ Resonance frequency of structural vibrations of vibration unit ] / n ) \times a \qquad ( 1 )$$
wherein n represents an integer from 1 to 100 and a represents 0.9 to 1.1.

2. The droplet formation device according to claim 1, wherein n is equal to 1.

3. The droplet formation device according to claim 1, wherein the vibration unit is a piezoelectric element.

4. The droplet formation device according to claim 1, further having
a tubular fixing member surrounding a periphery of the liquid holding module,
the fixing member being adhered to the vibration module by a first adhesive layer, and
an elastic modulus of a material forming the first adhesive layer is 1 MPa or more and 100 MPa or less.

5. The droplet formation device according to claim 4, wherein
the vibration unit and the membranous element are bonded by a second adhesive layer, and
a material forming the second adhesive layer is harder than the material forming the first adhesive layer.

6. A driving method for an ejection head which ejects droplets of a liquid, wherein the ejection head comprises
a tubular liquid holding module which holds the liquid, and
a vibration module which ejects the droplets based on an electric signal,
wherein the vibration module includes
a membranous element which has an ejection port from which the droplets are ejected, and
a vibration unit which causes the membranous element to vibrate based on the electric signal,
wherein the vibration module covers one end of the liquid holding module and forms a liquid chamber, which holds the liquid together with the liquid holding module; and
in the liquid chamber, the other end of the liquid holding module is open to the atmosphere;
wherein the electric signal having a drive frequency as shown in Expression (1) below is supplied to the vibration unit:
$$[ Drive frequency ] = ( [ Resonance frequency of structural vibrations of vibration unit ] / n ) \times a \qquad ( 1 )$$
wherein n represents an integer from 1 to 100 and a represents 0.9 to 1.1.
